(19) United States
(12) Patent Application Publication
(10) Pub. No.: US 2014/0080498 A1
(43) Pub. Date: Mar. 20, 2014

(54) CONTROLLER FOR COORDINATING WIRELESS TRANSMISSIONS BETWEEN A PLURALITY OF RADIO UNITS AND ONE OR MORE USER DEVICES

(71) Applicant: Kabushiki Kaisha Toshiba, Minato-ku (JP)

(72) Inventor: Parag Gopal KULKARNI, Bristol (GB)

(73) Assignee: Kabushiki Kaisha Toshiba, Manato-ku (JP)

(21) Appl. No.: 14/027,484

(22) Filed: Sep. 16, 2013

(30) Foreign Application Priority Data
Sep. 18, 2012 (GB) 1216652.6

(51) Int. Cl. H04W 72/06

(52) U.S. Cl. CPC H04W 72/06
USPC 455/452.1

(57) ABSTRACT

A controller for coordinating wireless transmissions between a plurality of radio units and one or more user devices, each radio unit having a respective geographic area of coverage. The controller comprises a first module for signaling each radio unit to broadcast a pilot signal over its respective geographic area of coverage, the pilot signal being designed to elicit a response signal from each user device located within the radio unit's area of coverage, and a second module for receiving from each radio unit information specifying the user devices from which the respective radio unit has received a response signal. The controller is configured to use the information received from the radio units to determine which user devices are located within range of each radio unit.

### FIELD

Embodiments described herein relate to a controller for coordinating wireless transmissions between a plurality of radio units and one or more user devices,

### BACKGROUND

Coordinated Antenna Base-station (CoAB) systems can provide improved cellular coverage and capacity in large indoor environments, e.g. in office buildings with several floors, shopping malls etc. A typical CoAB deployment comprises of a master unit (MU, e.g. one per building) and several hub units (HU, one per floor). Each hub unit HU may communicate with several remote units (RU), there being multiple RUs deployed on a single floor, with each one being uniquely identifiable by the HU. Reusing the entire frequency band at each HU (and hence at the RUs connected to the HU) offers scope for better coverage/capacity. However interference between RUs needs to be carefully managed.

In traditional cellular systems, resource allocation aims to maximise the aggregate throughput by allocating each subcarrier exclusively to the user device (UE) with the best channel quality indicator CQI for the subcarrier under consideration. However, the complexity of such allocation is proportional to the number of sub-carriers. Given the large number of subcarriers e.g. in an LTE system, the complexity of such allocation may be very high. One solution is to allocate resources in chunks (i.e. sets of subcarriers, also referred to as Resource Blocks RB) rather than on a subcarrier-by-subcarrier basis to terminals based on the CQI conditions reported by the user device. However, such an approach does not take into account the local network neighbourhood of the user device, and allows for the possibility that two closely located user devices may be allocated similar resource blocks, leading to a risk of interference.

### BRIEF DESCRIPTION OF FIGURES

FIG. 1 shows a Coordinated Antenna Base-station (CoAB) system including a controller according to an embodiment;

FIG. 2 shows a schematic of a method employed by the system of FIG. 1;

FIG. 3 shows a schematic of how pilot signals sent from the radio units of FIG. 1 may be offset in time from one another;

FIG. 4 shows a table in which data received by the controller of FIG. 1 is used to determine the relative distances between each user device and radio unit according to an embodiment;

FIG. 5 shows an example of a resource allocation matrix for the Coordinated Antenna Base-station (CoAB) system of FIG. 1;

FIG. 6 shows a Coordinated Antenna Base-station (CoAB) system including a controller according to an embodiment, wherein the controller communicates with a plurality of radio units via a plurality of hub units;

FIG. 7 shows an example of a table compiled by a controller on receipt of information encoded in response signals sent from the user devices in FIG. 6; and

FIG. 8 shows an example of a resource allocation matrix for the Coordinated Antenna Base-station (CoAB) system of FIG. 6.

### DETAILED DESCRIPTION

A first embodiment provides a controller for coordinating wireless transmissions between a plurality of radio units and one or more user devices, each radio unit having a respective geographic area of coverage, the controller comprising:
a first module for signaling each radio unit to broadcast a pilot signal over its respective geographic area of coverage, the pilot signal being designed to elicit a response signal from each user device located within the radio unit's area of coverage,
a second module for receiving from each radio unit information specifying the user devices from which the respective radio unit has received a response signal,
the controller being configured to use the information received from the radio units to determine which user devices are located within range of each radio unit.

In some embodiments, the information that the controller receives from a respective radio unit may specify one or more characteristics of the response signals that the radio unit has received from the user devices.

In some embodiments, for each user device, the controller is configured to determine the radio units for which the user device is in range, and to rank those radio units in terms of their distance from the user device.

In some embodiments, for each user device, the controller is configured to determine each respective radio unit's place in the ranking based on one or more of the characteristics of the response signal that the radio unit receives from that user device.

In some embodiments, said characteristics include the strength of the response signal that the respective radio unit receives from the user device. In some embodiments, said characteristics include the delay in time between transmitting a pilot signal from the respective radio unit and receiving the response signal at the radio unit.

In some embodiments, the response signal that the user device sends to the respective radio unit includes an indication of the strength of the pilot signal that the user device has received from the radio unit. The controller may be configured to determine the radio unit's place in the ranking based on the strength of the pilot signal indicated in the response signal.

In some embodiments, the controller is configured to use the information received from the radio units to allocate one or more resource blocks to each radio unit. In some embodiments, each resource block comprises a group of one or more subcarriers.

In some embodiments, the controller is configured to periodically request the radio units to broadcast new pilot signals and subsequently receive updated information from each radio unit. The controller may be configured to reallocate the resource blocks based on the updated information.

In some embodiments, the controller is configured to generate a resource allocation matrix comprising a list of each radio unit and the resource blocks presently allocated to that radio unit.

In some embodiments, the controller is configured to transmit and receive information to and from the radio units via one or more hub units.

Another embodiment provides a method of coordinating wireless transmissions between a plurality of radio units and one or more user devices, each radio unit having a respective geographic area of coverage, the method comprising:
broadcasting a respective pilot signal from each radio unit, the pilot signal being designed to elicit response signals from the user devices located within the respective radio unit's area of coverage,
transmitting information from each radio unit to a controller, the information specifying the user devices from which the respective radio unit has received a response signal, and
determining at the controller the user devices that are located within range of each radio unit.

In some embodiments, the information that the controller receives from a respective radio unit may specify one or more characteristics of the response signals that the radio unit has received from the user devices.

In some embodiments, the method comprises determining, for each user device, the radio units for which the user device is in range, and ranking those radio units in terms of their distance from the user device.

In some embodiments, each respective radio unit's place in the ranking is determined based on one or more characteristics of the response signal that the radio unit receives from the user device.

In some embodiments, the characteristics include the strength of the response signal that the respective radio unit receives from the user device.

In some embodiments, the response signal that the user device sends to the respective radio unit includes an indication of the strength of the pilot signal that the user device has received from the radio unit. The method may comprise determining the radio unit's place in the ranking based on the strength of the pilot signal indicated in the response signal.

In some embodiments, the characteristics include the delay in time between transmitting a pilot signal from the respective radio unit and receiving the response signal at the radio unit.

In some embodiments, the information received from the radio units at the controller is used to allocate one or more resource blocks to each radio unit.

In some embodiments, the controller periodically requests the radio units to broadcast new pilot signals and subsequently receives updated information from each radio unit. The resource blocks may be reallocated based on the updated information.

In some embodiments, the method comprises generating a resource allocation matrix comprising a list of each radio unit and the resource blocks presently allocated to each radio unit.

Embodiments described herein provide a method to aggregate and maintain information collected from radio units at a controller, maintain information pertaining to the resources allocated by the controller and to share this information with other hub units. Such information (which encompasses who is using what in the neighbourhood) can be useful during a resource allocation/re-allocation process in order to minimise interference by identifying potential interferers.

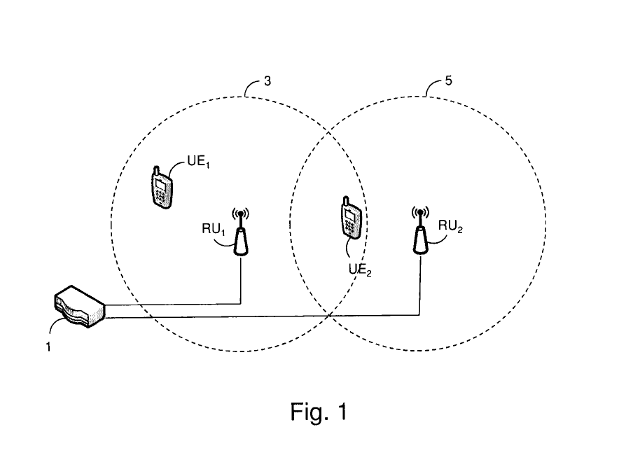

FIG. 1 shows a Coordinated Antenna Base-station (CoAB) system including a controller 1 according to an embodiment. The controller 1 is used to control wireless transmissions from a pair of radio units RU₁, RU₂. Each radio unit has a respective area of geographic coverage 3, 5. The geographic area of coverage defines the region over which wireless signals broadcast from the radio unit remain above a threshold intensity, and so will be detectable by a user device.

As shown in FIG. 1, a first user device UE₁ is located within the area of coverage of the first radio unit RU₁. A second user device UE₂ is situated at a point within the area of coverage of both the first and second radio units. Consequently, UE₁ will be able to detect signals broadcast from the first radio unit RU₁ only, whilst UE₂ will be capable of detecting signals broadcast from both the first and second radio units.

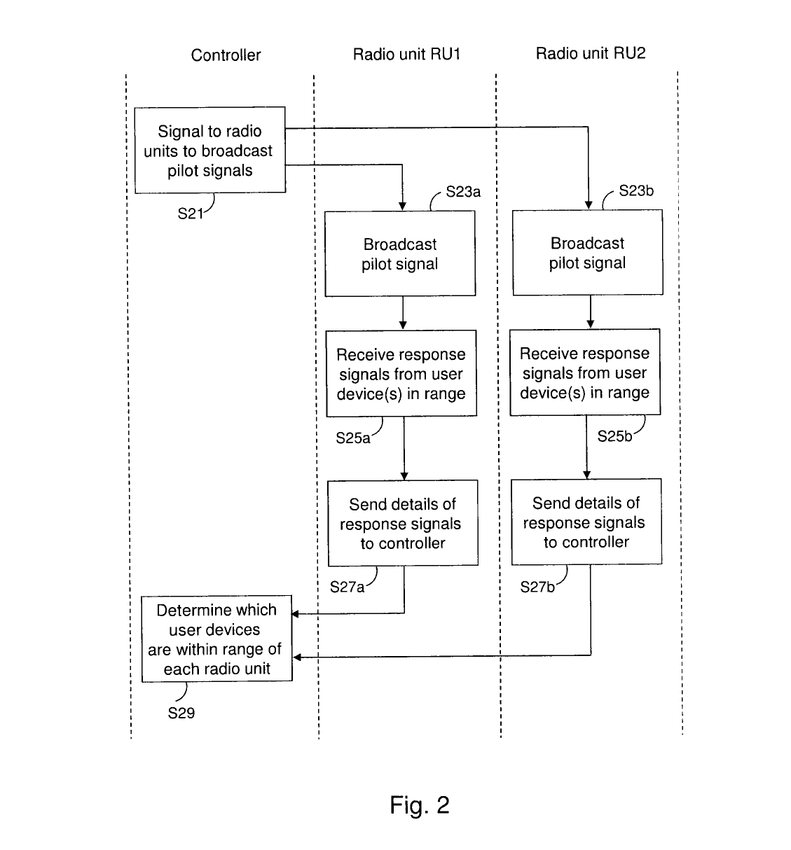

In the present embodiment, the controller determines which of the two user devices UE₁ and UE₂ are within range of each radio unit. The method by which the controller does so is shown schematically in FIG. 2. At step S21, the controller signals to each radio unit to broadcast a pilot signal over its respective area of coverage. The radio units then broadcast their respective pilot signals (steps S23a, S23b). When a user device receives one of the pilot signals, it decodes the pilot signal to determine the identity of the radio unit from which the signal has been broadcast. The user device then broadcasts a response signal to the radio unit in question, wherein the response signal includes an identification of the user device. In step S25a, S25b, the radio units receive the response signals sent from the user device(s) in their respective areas of coverage and use this information to determine which user devices are presently within range. The radio units then relay this information to the controller (step S27a, S27b). The controller compiles the information received from each radio unit to determine which user devices are presently within range of each radio unit.

In the example shown in FIG. 1, UE₁ lies within range of the first radio unit only and will therefore detect the pilot signal from RU₁, but not from RU₂. User device UE₂, in contrast, will detect the pilot signals sent from both radio units. Consequently, the first radio unit RU₁ will receive a response signal from UE₁ whilst the second radio unit will receive a response signal from both UE₁ and UE₂. The controller will then be able to determine that UE1 is within range of radio unit 1, and UE₂ is in range of both RU₁ and RU₂.

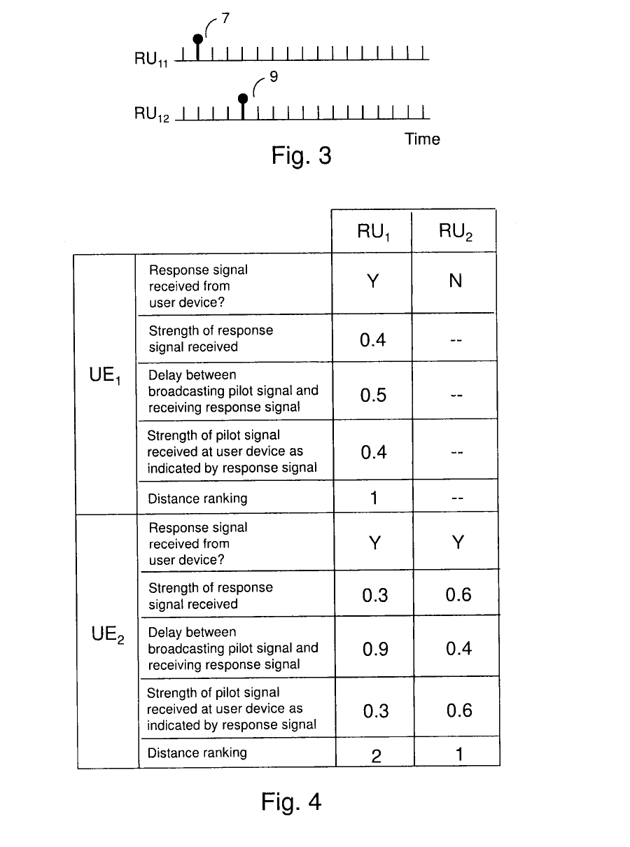

In some embodiments, the controller may configure each radio unit to transmit a pilot signal at a predefined timeslot. For example, as shown in FIG. 3, each radio unit may transmit its pilot signal in a timeslot 7, 9 that is unique to that radio unit.

In some embodiments, the response signal that is sent from a respective user device to a radio unit may also include information that can be used to estimate the distance between the radio unit and the user device in question. For example, the response signal may include an indication of the power level of the pilot signal at the point it was received by the user device. The power of the pilot signal will diminish as a function of the distance between the radio unit and the user device. Therefore, the power of the pilot signal as received by the user device will provide an indication of the distance of the user device from the radio unit. When the response signal includes this information, the radio unit (or controller) will be able to estimate the distance between the radio unit and the user device.

Alternatively, or in addition, the radio unit or controller may estimate the distance between the radio unit and the user device based on the actual strength of the response signal that the radio unit receives from the user device. In some embodiments, the radio unit may estimate the distance based on the temporal delay between transmitting a pilot signal, and receiving the response signal from the user device.

Where the radio unit estimates the distance between itself and a respective user device, it may relay that estimation to the controller. Alternatively, the radio unit may function in a passive mode and simply relay details of the response signal(s) to the controller. The controller may then itself process the data to estimate the distance between the radio unit and each user device that the radio unit has received a response signal from. Doing so can reduce the processing burden on the radio unit.

In this way, the controller is able to determine not only which user devices are within range of each radio unit, but is also able to obtain information concerning the distance between each user device and the radio units that they are in contact with.

In some embodiments, the controller may store the information it receives from the radio units in the form of a table. FIG. 4 shows an example of such a table for the arrangement shown in FIG. 1.

The table indicates that UE₁ is within range of RU₁ alone, whilst UE₂ is within range of both RU₁ and RU₂. In addition, the table of FIG. 4 also includes various data items that can be used to estimate the distance between each radio unit and user device. In the example shown in FIG. 4, these data items include a measurement of the strength of the pilot signal received by the user device, the delay between broadcasting the pilot signal from a respective radio unit and receiving a response from each user device, and the strength of the response signal received at the radio unit.

Since the distance between the first user device UE₁ and the radio unit RU₁ is smaller than the distance between the second user device UE₂ and the radio unit RU₁, the strength of the response signal that RU₁ receives from UE₁ (0.4) is greater than that of the response signal that RU₁ receives from UE₂ (0.3). Similarly, the delay between broadcasting the pilot signal from RU₁ and receiving a response signal from UE₁ (0.5) is shorter than the delay between broadcasting the pilot signal from RU₁ and receiving the response signal from UE₂ (0.9).

Since UE₂ is within range of both RU₁ and RU₂, the entry for UE₂ includes data for both radio units. Here, it can be seen that the response signal received at RU₂ from UE₂ (0.6) is greater than that received at RU₁ (0.3). The same result is mirrored by the relative strength of the pilot signals that UE₂ receives from these two radio units.

Based on the information encoded in the response signals, the controller is able to rank the radio units in terms of their distance from each user device. In the case of user device UE₁, the only radio unit within range is RU₁, hence RU₁ will be awarded a distance ranking of 1 by default. In the case of UE₂, the controller is able to determine that UE₂ lies closer to RU₂ than it does to RU₁. Consequently, the controller assigns a distance ranking of 1 to RU₂, and a ranking of 2 to RU₁. In this way, the controller is able to build up a picture of the network neighbourhood of each user device.

The controller may use the data received from the radio units to mitigate the effects of interference. In the example shown in FIG. 1, RU₁ is communicating with UE₁, whilst RU₂ is communicating with UE₂. However, since UE₂ is also within range of UE₁, it is possible that transmissions between RU₂ and UE₂ will be subject to interference from RU₁. The risk of interference can be reduced, for example, by ensuring that RU₁ and RU₂ transmit on separate frequencies, which are located far apart on the frequency spectrum.

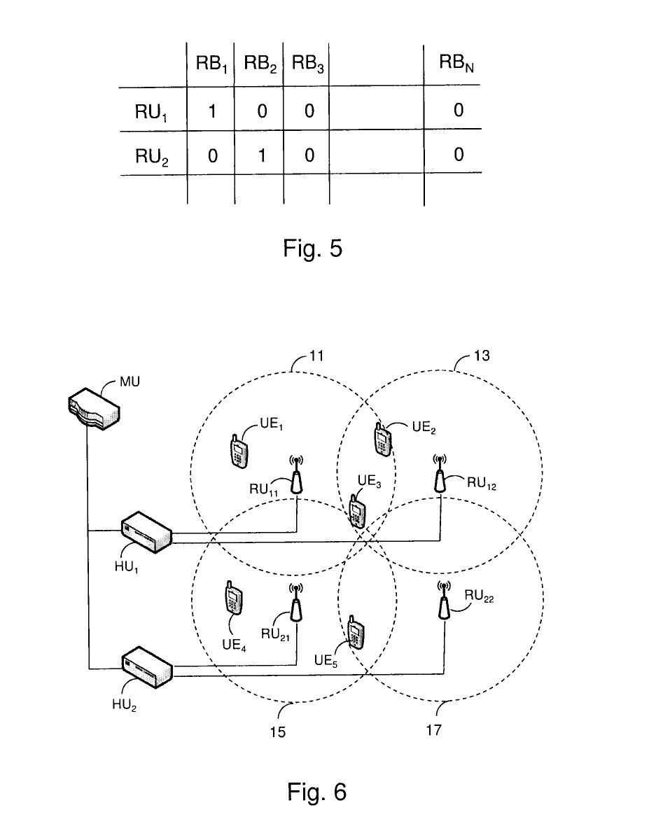

The controller may use the information in FIG. 4 to determine the resource blocks that should be assigned to each radio unit RU₁ and RU₂. FIG. 5 shows an example of a resource allocation matrix compiled by the controller of FIG. 1. Each radio unit RU₁, RU₂ can be allocated one or more radio resource blocks RB₁, RB₂ . . . , RB_{N} for transmissions, where each resource block itself comprises a group of one or more subcarriers. In the matrix, a value of 1 is used to denote that a particular resource block is allocated to a radio unit, whilst a value of 0 denotes that the radio unit in question is not presently allocated that resource block. In the example shown in FIG. 5, the first radio unit RU₁ is allocated resource block RB₁, whilst the second radio unit RU₂ is allocated resource block RB₂. In this way, it is possible to reduce interference at user device UE₂, as the user device can filter signals received from the two radio units based on their different frequencies.

The resource allocation matrix may be updated by the controller in response to changes in the location and/or activity of the various user devices.

FIG. 6 shows an embodiment in which the controller 1 takes the form of a master unit MU that communicates with the radio units via a plurality of hub units HU₁ and HU₂. The hub units function as intermediaries between the controller and one or more radio units.

In this embodiment, a first pair of radio units RU₁₁ and RU₁₂ are both controlled via the first hub unit HU₁, whilst a second pair of radio units RU₂₁ and RU₂₂ are controlled via the second hub HU₂. The radio units RU₁₁, RU₁₂, RU₂₁, and RU₂₂ have respective geographic areas of coverage 11, 13, 15, 17.

A first user device UE₁ is located in the area of coverage of the first radio unit RU₁₁. A second user device UE₂ is located in the area of coverage of both the first radio unit RU₁₁ and the second radio unit RU₁₂ A third user device UE₃ is located within the area of coverage of the first and second radio units RU₁₁ and RU₁₂ and also the third radio unit RU₂₁. User device UE₄ is located within range of the third radio unit RU₂₁ only, and UE₅ is within range of both the third and fourth radio units RU₂₁ and RU₂₂.

In common with embodiments described above, the controller is configured to signal to each radio unit to broadcast a pilot signal over its respective geographic area of coverage. To do so, the controller MU sends a signal to the hub units HU₁ and HU₂, which in turn relay the signal to their respective pairs of radio units RU₁₁/RU₁₂ and RU₂₁/RU₂₂ in order to cause the radio units to broadcast the pilot signals. As before, each radio unit will receive a response signal from the user devices located within its respective geographic area of coverage. The information encoded in the response signals is relayed back to the respective hub unit to which the radio unit in question is connected. The hub units HU₁ and HU₂ compile the data from their respective pairs of radio units RU₁₁/RU₁₂ and RU₂₁/RU₂₂ and relay this back to the controller MU. The signals sent from each hub unit to the controller may include an identification of the hub unit. The controller is thereby able to determine which user devices are in range of the different radio units.

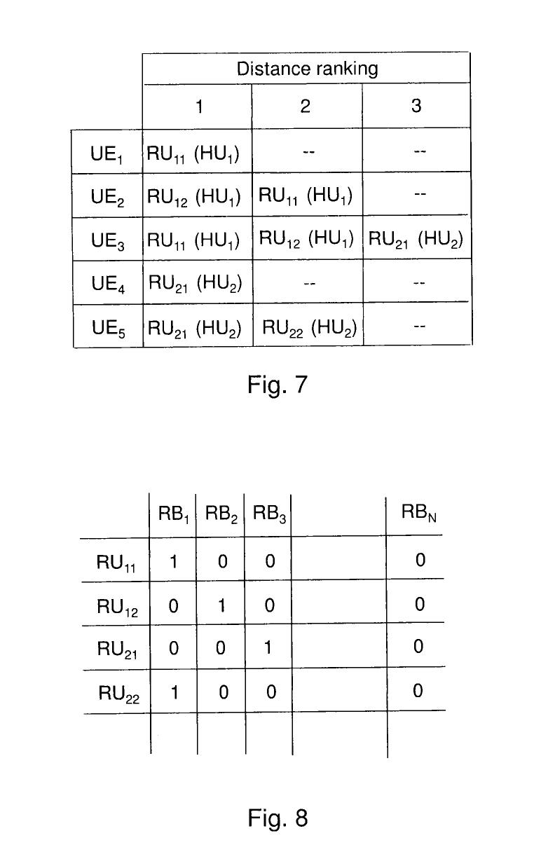

FIG. 7 shows an example of a table compiled by the controller on receipt of the information encoded in the response signals sent from each user device. For each user device UE₁-UE₅, the controller is able to determine:
i) the radio units for which the user device is in range
ii) the relative distance of the user device from each of those radio units
iii) the hub unit being used to communicate with each respective radio unit

For example, referring to row one of the table of FIG. 7, user device UE₁ is in range of radio unit RU₁₁ alone, which is connected to hub unit HU₁. In contrast, referring to row 3 of the table, user device UE₃ is seen to be within range of RU₁₁ and RU₁₂, both of which are communicating with the controller via hub unit HU₁. User device UE₃ is also within range of RU₂₁, which is linked to the controller via HU₂. Based on the strength of the pilot signals received by the user devices (or the strength of the response signals received by the radio units), the controller is able to determine that user device UE₃ is closest to radio unit RU₁₁, followed by RU₁₂, and then RU₂₁.

As before, the controller may use the information shown in FIG. 7 to update a resource allocation matrix for the system. By knowing which neighbouring radio units a user device is able to detect signals from, and by knowing the resources that these neighbouring radio units are using, it is possible to identify potential sources of interference (if any). This information can then aid in the resource allocation/reallocation procedure with the aim of eliminating (where possible) or minimising the impact of interference.

For example, based on the information shown in FIG. 7, the controller can determine that user device UE₃ is within range of 3 separate radio units, RU₁₁, RU₁₂, and RU₂₁. In order to avoid interference at UE₃, the controller can first allocate a different resource block to radio units RU₁₁ and RU₁₂, from that which is allocated to radio unit RU₂₁. The controller is also able to determine that the radio units RU₁₁ and RU₁₂ should each be allocated their own, distinct frequency bands, otherwise there is a risk of interference occurring at user device UE₂ which still lies within range of both of those stations.

FIG. 8 shows a resource allocation matrix for the embodiment shown in FIG. 6. Each one of the 3 radio units RU₁₁, RU₁₂, and RU₂₁ has been allocated a separate resource block, thereby reducing the chance of interference occurring at user devices UE₃ and UE₂. The fourth radio unit RU₂₂ has meanwhile been allocated the same resource block as RU₁₁. Assigning the same resource block to radio units RU₁₁ and RU₂₂ does not present a problem because there is no single user device presently located within both their areas of coverage; the only user device that lies within range of radio unit RU₂₂ is UE₅. Although UE₅ is also located within range of both RU₂₁, RU₂₁ has already been assigned a resource block different from that of RU₁₁. Therefore, from the point of view of UE₅, there is no risk in allocating the same resource block as RU₁₁ to RU₂₂.

Thus, embodiments described herein provide information concerning the radio neighbourhood around a user device (for example, the radio units that a user device can hear and the resources that are currently allocated to these radio units). As a result, it is possible to make a better informed decision as to what resources should be allocated to a particular user device. For example, embodiments described herein allow the controller to establish the following:
i) which are the other hub units/radio units in the vicinity of a given user device?
ii) which of these is the nearest/furthest from the user device?
iii) what resources are currently being used in each of these hub units/radio units?
iv) are there any particular resource block allocations that may be resulting in interference to the user device?
v) Are there resources that are presently not in use by these hub unit/radio units and that can be allocated to the user device?

This is in marked contrast to conventional DAS systems, in which a controller will typically allocate resources to a user device based on the channel quality information CQI reported by the user device.

While certain embodiments have been described, these embodiments have been presented by way of example only, and are not intended to limit the scope of the invention. Indeed, the novel methods, devices and systems described herein may be embodied in a variety of forms; furthermore, various omissions, substitutions and changes in the form of the methods and systems described herein may be made without departing from the spirit of the invention. The accompanying claims and their equivalents are intended to cover such forms or modifications as would fall within the scope and spirit of the inventions.

1. A controller for coordinating wireless transmissions between a plurality of radio units and one or more user devices, each radio unit having a respective geographic area of coverage, the controller comprising:
a first module for signaling each radio unit to broadcast a pilot signal over its respective geographic area of coverage, the pilot signal being designed to elicit a response signal from each user device located within the radio unit's area of coverage,
a second module for receiving from each radio unit information specifying the user devices from which the respective radio unit has received a response signal,
the controller being configured to use the information received from the radio units to determine which user devices are located within range of each radio unit.

2. A controller according to claim 1, wherein for each user device, the controller is configured to determine the radio units for which the user device is in range, and to rank those radio units in terms of their distance from the user device.

3. A controller according to claim 2, wherein for each user device, the controller is configured to determine a respective radio unit's place in the ranking based on one or more characteristics of the response signal that the radio unit receives from that user device.

4. A controller according to claim 3, wherein said characteristics include the strength of the response signal that the respective radio unit receives from the user device.

5. A controller according to claim 3, wherein the response signal that the user device sends to the respective radio unit includes an indication of the strength of the pilot signal that the user device has received from the radio unit, the controller being configured to determine the radio unit's place in the ranking based on the strength of the pilot signal indicated in the response signal.

6. A controller according to claim 3, wherein said characteristics include the delay in time between transmitting a pilot signal from the respective radio unit and receiving the response signal at the radio unit.

7. A controller according to claim 1, wherein the controller is configured to use the information received from the radio units to allocate one or more resource blocks to each radio unit.

8. A controller according to claim 7, wherein the controller is configured to periodically request the radio units to broadcast new pilot signals and subsequently receive updated information from each radio unit, the controller being configured to reallocate the resource blocks based on the updated information.

9. A controller according to claim 7, wherein the controller is configured to generate a resource allocation matrix comprising a list of each radio unit and the resource blocks presently allocated to that radio unit.

10. A controller according to claim 1, wherein the controller is configured to transmit and receive information to and from the radio units via one or more hub units.

11. A method of coordinating wireless transmissions between a plurality of radio units and one or more user devices, each radio unit having a respective geographic area of coverage, the method comprising:
broadcasting a respective pilot signal from each radio unit, the pilot signal being designed to elicit response signals from the user devices located within the respective radio unit's area of coverage,
transmitting information from each radio unit to a controller, the information specifying the user devices from which the respective radio unit has received a response signal, and
determining at the controller the user devices that are located within range of each radio unit.

12. A method according to claim 11, further comprising determining, for each user device, the radio units for which the user device is in range, and ranking those radio units in terms of their distance from the user device.

13. A method according to claim 12, wherein each respective radio unit's place in the ranking is determined based on one or more characteristics of the response signal that the radio unit receives from the user device.

14. A method according to claim 13, wherein said characteristics include the strength of the response signal that the respective radio unit receives from the user device.

15. A method according to claim 13, wherein the response signal that the user device sends to the respective radio unit includes an indication of the strength of the pilot signal that the user device has received from the radio unit, and the method comprises determining the radio unit's place in the ranking based on the strength of the pilot signal indicated in the response signal.

16. A method according to claim 13, wherein said characteristics include the delay in time between transmitting a pilot signal from the respective radio unit and receiving the response signal at the radio unit.

17. A method according to claim 11, wherein the information received from the radio units at the controller is used to allocate one or more resource blocks to each radio unit.

18. A method according to claim 17, wherein the controller periodically requests the radio units to broadcast new pilot signals and subsequently receives updated information from each radio unit, wherein the resource blocks are reallocated based on the updated information.

19. A method according to claim 17, comprising generating a resource allocation matrix comprising a list of each radio unit and the resource blocks presently allocated to each radio unit.

20. A controller according to claim 4, wherein the response signal that the user device sends to the respective radio unit includes an indication of the strength of the pilot signal that the user device has received from the radio unit, the controller being configured to determine the radio unit's place in the ranking based on the strength of the pilot signal indicated in the response signal.

21. A controller according to claim 8, wherein the controller is configured to generate a resource allocation matrix comprising a list of each radio unit and the resource blocks presently allocated to that radio unit.

22. A method according to claim 14, wherein the response signal that the user device sends to the respective radio unit includes an indication of the strength of the pilot signal that the user device has received from the radio unit, and the method comprises determining the radio unit's place in the ranking based on the strength of the pilot signal indicated in the response signal.

23. A method according to claim 18, comprising generating a resource allocation matrix comprising a list of each radio unit and the resource blocks presently allocated to each radio unit.
